(19) United States
(12) Patent Application Publication
(10) Pub. No.: US 2026/0002889 A1
(43) Pub. Date: Jan. 1, 2026

(54) TEMPERATURE ADJUSTING DEVICE, METHOD, AND PROGRAM OF RADIOGRAPHY APPARATUS, AND RADIOGRAPHY APPARATUS

(71) Applicant: FUJIFILM Corporation, Tokyo (JP)

(72) Inventor: Takafumi ISHITSU, Tokyo (JP)

(73) Assignee: FUJIFILM Corporation, Tokyo (JP)

(21) Appl. No.: 19/250,129

(22) Filed: Jun. 26, 2025

(30) Foreign Application Priority Data
Jun. 28, 2024 (JP) 2024-105535

(51) Int. Cl. G01N 23/046; G06F 1/3228

(52) U.S. Cl. CPC G01N 23/046; G06F 1/3228; G01N 2223/306; G01N 2223/3103; G01N 2223/3106; G01N 2223/419

(57) ABSTRACT

A processor is configured to acquire instruction information for setting the radiography apparatus to a power-saving mode in which power consumption is smaller than power consumption in a case where the radiography apparatus is operated, and information on a maintenance time during which the power-saving mode is maintained, set a holding temperature of the detector during the power-saving mode in accordance with the maintenance time in a case where the maintenance time is equal to or longer than a predetermined first threshold value, and control driving of a temperature adjuster such that the temperature of the detector is set to the holding temperature.

### CROSS-REFERENCE TO RELATED APPLICATION

The present application claims priority from Japanese Patent Application No. 2024-105535, filed on Jun. 28, 2024, the entire disclosure of which is incorporated herein by reference.

### BACKGROUND

### Technical Field

The present disclosure relates to a temperature adjusting device, a method, and a program of a radiography apparatus, and a radiography apparatus.

### Related Art

In recent years, miniaturization of a detector used in a computed tomography (CT) apparatus has progressed, and there is a need to improve reliability of connection of the detector. In particular, in a photon counting-type detector used in a photon counting computed tomography (PCCT) apparatus, miniaturization of a detection element is remarkable. In addition, since there is a restriction on a high-temperature bonding process such as soldering due to a heat resistance of a detector to be used, bonding with conductive epoxy is frequently used, and it is necessary to improve the reliability of the connection.

Here, the detector used in the CT apparatus needs to keep sensitivity characteristics constant with high accuracy. Therefore, the detector is heated by a heater or cooled by a fan to prevent a change in sensitivity of the detector due to a change in ambient temperature.

On the other hand, in a case where a detector in which the detection element is miniaturized is kept at a high temperature, deterioration of a material and a joint portion of the detection element due to heat and the like is a problem. In addition, power consumption also increases. Therefore, a method of lowering a temperature of the detector at night or the like in a case where the device is not used has been proposed (refer to JP2003-014860A and JP2016-086933A).

However, in a case where a temperature of a detector is increased or decreased, there is a possibility that deterioration of the detector due to a heat cycle is accelerated.

### SUMMARY

The present disclosure has been made in view of the above-described circumstances, and an object of the present disclosure is to prevent the deterioration of the detector due to the heat cycle.

There is provided a temperature adjusting device of a radiography apparatus according to the present disclosure including a detector that detects radiation emitted from a radiation source and transmitted through a subject and a temperature adjuster that adjusts a temperature of the detector, the temperature adjusting device comprising:
a processor,
in which the processor is configured to
   acquire instruction information for setting the radiography apparatus to a power-saving mode in which power consumption is smaller than power consumption in a case where the radiography apparatus is operated, and information on a maintenance time during which the power-saving mode is maintained,
   set a holding temperature of the detector during the power-saving mode in accordance with the maintenance time in a case where the maintenance time is equal to or longer than a predetermined first threshold value, and
   control driving of the temperature adjuster such that the temperature of the detector is set to the holding temperature.

In the temperature adjusting device according to the present disclosure, the processor may be configured to control the driving of the temperature adjuster such that the temperature of the detector is set to the holding temperature at a certain ratio after the power-saving mode is set.

In addition, in the temperature adjusting device according to the present disclosure, the processor may be configured to, in a case where the power-saving mode is set, delay a start of processing of controlling the driving of the temperature adjuster in a case where a peripheral temperature of the detector is equal to or higher than a predetermined second threshold value, as compared with a case where the peripheral temperature of the detector is lower than the second threshold value.

In addition, in the temperature adjusting device according to the present disclosure, the processor may be configured to prohibit processing of controlling the driving of the temperature adjuster such that the temperature of the detector is set to the holding temperature in a case where the maintenance time is less than the first threshold value.

There is provided a radiography apparatus according to the present disclosure comprising:
a detector that detects radiation emitted from a radiation source and transmitted through a subject;
a temperature adjuster that adjusts a temperature of the detector; and
the temperature adjusting device according to the present disclosure.

In the radiography apparatus according to the present disclosure, the detector may be a photon counting-type detector that outputs a detection signal corresponding to a photon energy of the radiation.

In addition, in the radiography apparatus according to the present disclosure, the temperature adjusting device may include a heater.

In addition, in the radiography apparatus according to the present disclosure, the temperature adjusting device may include a cooling fan.

There is provided a temperature adjusting method of a radiography apparatus according to the present disclosure including a detector that detects radiation emitted from a radiation source and transmitted through a subject and a temperature adjuster that adjusts a temperature of the detector, the temperature adjusting method comprising:
causing a computer to execute
   acquiring instruction information for setting the radiography apparatus to a power-saving mode in which power consumption is smaller than power consumption in a case where the radiography apparatus is operated, and information on a maintenance time during which the power-saving mode is maintained,
   setting a holding temperature of the detector during the power-saving mode in accordance with the maintenance time in a case where the maintenance time is equal to or longer than a predetermined first threshold value, and
   controlling driving of the temperature adjuster such that the temperature of the detector is set to the holding temperature.

There is provided a temperature adjusting program of a radiography apparatus according to the present disclosure including a detector that detects radiation emitted from a radiation source and transmitted through a subject and a temperature adjuster that adjusts a temperature of the detector, the temperature adjusting program comprising:
causing a computer to execute
   a procedure of acquiring instruction information for setting the radiography apparatus to a power-saving mode in which power consumption is smaller than power consumption in a case where the radiography apparatus is operated, and information on a maintenance time during which the power-saving mode is maintained,
   a procedure of setting a holding temperature of the detector during the power-saving mode in accordance with the maintenance time in a case where the maintenance time is equal to or longer than a predetermined first threshold value, and
   a procedure of controlling driving of the temperature adjuster such that the temperature of the detector is set to the holding temperature.

A technology of the present disclosure can also be applied to a temperature adjusting program product.

According to the present disclosure, it is possible to prevent deterioration of the detector due to a heat cycle.

### BRIEF DESCRIPTION OF THE DRAWINGS

FIG. 1 is a schematic configuration diagram of a medical image capturing system including a radiography apparatus comprising a temperature adjusting device according to an embodiment of the present disclosure.

FIG. 2 is a view for describing a configuration related to temperature adjustment of a detector panel.

FIG. 3 is a diagram showing a hardware configuration of the temperature adjusting device according to the present embodiment.

FIG. 4 is a diagram showing a functional configuration of the temperature adjusting device according to the present embodiment.

FIG. 5 is a flowchart showing processing performed in the present embodiment.

### DETAILED DESCRIPTION

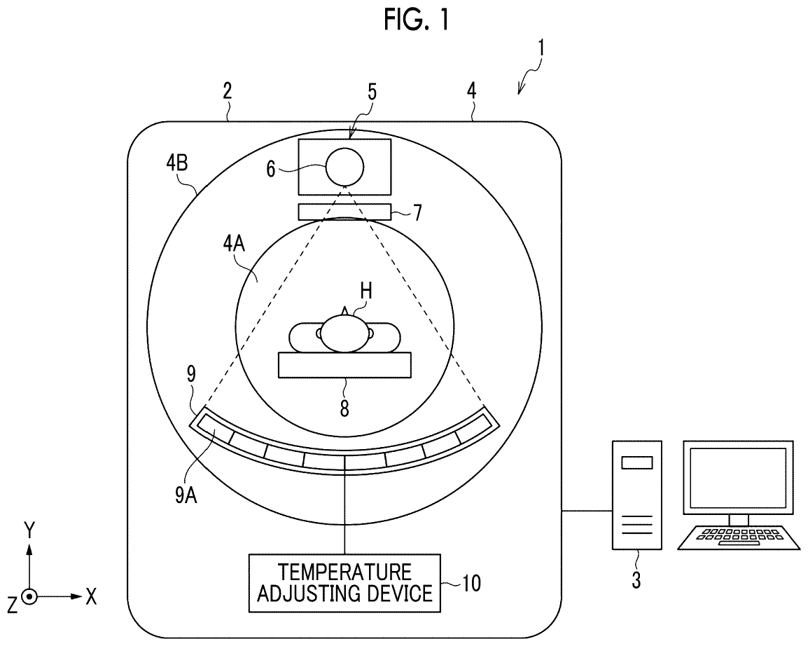

Hereinafter, an embodiment of the present disclosure will be described in detail with reference to the accompanying drawings. First, an example of a configuration of a medical image capturing system including a radiography apparatus comprising a temperature adjusting device according to the present embodiment will be described. FIG. 1 is a schematic configuration diagram of a medical image capturing system comprising a radiography apparatus according to the present embodiment.

As shown in FIG. 1, a medical image capturing system 1 according to the present embodiment comprises a CT apparatus 2 and a console 3. The CT apparatus 2 comprises a gantry 4 and an examination table 8. In the following description, a lateral direction in FIG. 1 is defined as an X axis, a longitudinal direction is defined as a Y axis, and a direction orthogonal to an XY plane is defined as a Z axis. The CT apparatus 2 is an example of the radiography apparatus of the present disclosure.

The gantry 4 has an opening portion 4A, and a subject H as an imaging target is disposed in the opening portion 4A in a state of being placed on the examination table 8. The gantry 4 and the examination table 8 can be relatively moved in a Z axis direction.

A radiation source 5 having a radiation tube 6 and a bowtie filter 7 and a detector panel 9 are disposed inside the gantry 4 in a state where the radiation source 5 and the detector panel 9 faces each other with the subject H interposed therebetween. In addition, the gantry 4 is provided with a rotary plate 4B that is fixed at a position at which the radiation source 5 and the detector panel 9 face each other, and a drive mechanism (not shown) for rotating the rotary plate 4B.

In order to reduce an exposure dose in a peripheral portion, the bowtie filter 7 optimizes the exposure dose by increasing a dose near the center and reducing a dose around the periphery. Radiation emitted from the radiation tube 6 is molded into a beam shape suitable for a size of the subject H by the bowtie filter 7 and irradiates the subject H.

The detector panel 9 detects radiation transmitted through the subject H and generates projection data in accordance with a dose of the detected radiation. As an example, the detector panel 9 of the present embodiment is a photon counting-type detector, in which a plurality of detection elements that detect a photon energy that is an energy of a photon of incident radiation are arranged in an arc shape centered on a focal point of the radiation tube 6. The detector panel 9 outputs projection data in accordance with the photon energy. A pixel value at each pixel position of the projection data is a value of a detection signal output from each of the detection elements.

The detector panel 9 is configured by arranging a plurality of detector modules 9A in an arc shape in the X direction. A direction along the arc along which the detector modules 9A are arranged is referred to as a channel direction.

In addition, the CT apparatus 2 according to the present embodiment comprises a temperature adjusting device 10 for adjusting a temperature of the detector panel 9. The temperature of the detector panel 9 is controlled by the temperature adjusting device 10. A configuration related to temperature adjustment of the detector panel 9 will be described below.

In the present embodiment, X-rays are used as an example of the radiation.

The radiation tube 6 and the detector panel 9 are rotated around the subject H by rotating the rotary plate 4B by the drive mechanism. Radiation irradiation from the radiation tube 6 and the detection of the radiation by the detector panel 9 are repeated with the rotation of the radiation tube 6 and the detector panel 9, and thus a plurality of pieces of projection data at various projection angles for the subject H are acquired. The plurality of pieces of projection data acquired by the detector panel 9 are output to the console 3 and are reconstructed into a tomographic image.

The console 3 sets the dose of the radiation emitted from the radiation tube 6, a rotation speed of the rotary plate 4B in the gantry 4, a relative movement speed between the gantry 4 and the examination table 8, and the like based on an acquisition condition in a case where the projection data input by a user, such as a technician, is acquired.

The console 3 according to the present embodiment executes control of driving the CT apparatus 2, control related to acquiring projection data by imaging of the subject H, generation of a medical image, control of substance discrimination, and the like by an operator's input and a program for performing various types of processing. Here, in the present embodiment, various modes for driving the CT apparatus 2 can be set. For example, in the present embodiment, an operation mode for setting the CT apparatus 2 to an activation state and a power-saving mode for energizing the CT apparatus 2 for temperature adjustment of the detector panel 9 or the like, without imaging the subject H at night or the like, can be set such that the CT apparatus 2 can immediately capture the subject H. In the power-saving mode, power consumption in the CT apparatus 2 is smaller than that in the operation mode.

In a case where the power-saving mode is set, an activation time of the CT apparatus 2 can be set such that the power-saving mode is ended to be converted to the operation mode. For example, in a case where the CT apparatus 2 is set to the power-saving mode at an end time of an examination in the hospital, it is possible to set the activation time of the CT apparatus 2 to 8 a.m. on the next morning. In addition, in a case where the power-saving mode is set, it is also possible to set a maintenance time during which the power-saving mode is maintained instead of the activation time of the CT apparatus 2. In this case, the CT apparatus 2 is activated after the maintenance time has elapsed.

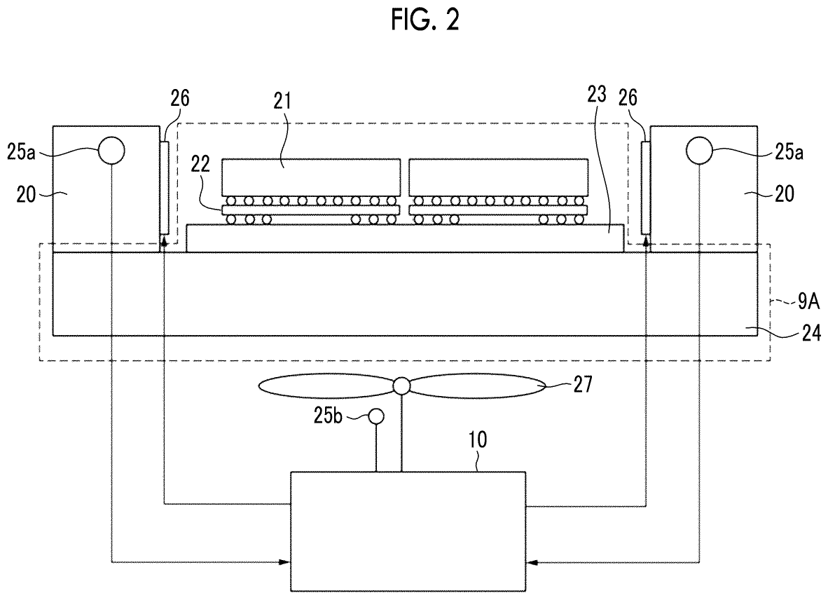

Next, the configuration related to the temperature adjustment of the detector panel 9 will be described. FIG. 2 is a view for describing the configuration related to the temperature adjustment of the detector panel. FIG. 2 is a view of one detector module 9A constituting the detector panel 9 as viewed from the channel direction. As shown in FIG. 2, the detector module 9A constituting the detector panel 9 is attached to a polygon 20.

The detector module 9A includes a detection element 21 consisting of a semiconductor layer that detects radiation, and an application specific integrated circuit (ASIC) 22. The ASIC 22 is mounted on a readout substrate 23, and the readout substrate 23 is mounted on a detector holding plate 24 for holding the detector module 9A.

A temperature sensor 25a, a temperature sensor 25b, a heater 26, and a cooling fan 27 are attached to the polygon 20. The temperature sensor 25a, the temperature sensor 25b, the heater 26, and the cooling fan 27 are connected to the temperature adjusting device 10. The detector module 9A is mechanically and thermally coupled to the polygon 20. Then, temperatures of the polygon 20 and the detector panel 9 are controlled by the temperature adjusting device 10 as will be described later. The heater 26 and the cooling fan 27 are an example of a temperature adjuster of the present disclosure.

The temperature sensor 25a measures the temperature of the detector panel 9 and outputs information indicating the measured temperature to the temperature adjusting device 10. The temperature sensor 25b measures a peripheral temperature of the detector panel 9 and outputs information indicating the measured temperature to the temperature adjusting device 10. It is preferable that the temperature sensor 25b is disposed at a position at which an intake or an exhaust temperature of the cooling fan 27 can be measured.

Drive control of the heater 26 is performed by the temperature adjusting device 10 such that the detector module 9A is heated to increase the temperature thereof. Driving of the heater 26 may be switched on and off, or may be controlled by the temperature adjusting device 10 such that a predetermined temperature is set.

The cooling fan 27 is disposed to blow air from the Y direction with respect to the detector holding plate 24, and the drive control of the cooling fan 27 is performed by the temperature adjusting device 10 through a driving source (not shown) such as a motor. Accordingly, the cooling fan 27 cools the detector panel 9 through the detector holding plate 24 to decrease the temperature of the detector panel 9. The drive control of the cooling fan 27 may be performed by the temperature adjusting device 10 to be rotated at a certain rotation speed, but may be performed by the temperature adjusting device 10 to be rotated at a rotation speed that can be changed such that a degree of cooling can be changed.

The polygon 20 and the detector holding plate 24 are made of a material having a relatively high thermal conductivity, such as aluminum, and heat generated from the detector module 9A is released into the gantry 4 from the polygon 20 and the detector holding plate 24.

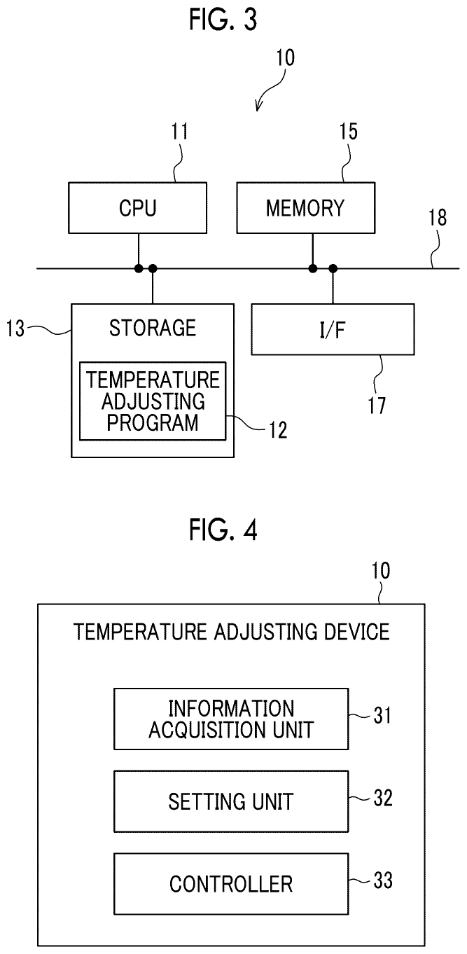

Next, the temperature adjusting device according to the present embodiment will be described. First, a hardware configuration of the temperature adjusting device according to the present embodiment will be described with reference to FIG. 3. As shown in FIG. 3, the temperature adjusting device 10 consists of a computer, and comprises a central processing unit (CPU) 11, a non-volatile storage 13, a memory 15 as a temporary storage area, and an I/F 17. The CPU 11, the storage 13, the memory 15, and the I/F 17 are connected to a bus 18. Note that the CPU 11 is an example of a processor according to the present disclosure.

The storage 13 is realized by a hard disk drive (HDD), a solid state drive (SSD), a flash memory, and the like. A temperature adjusting program 12 installed in the temperature adjusting device 10 is stored in the storage 13 as a storage medium. The CPU 11 reads out the temperature adjusting program 12 from the storage 13, loads the temperature adjusting program 12 in the memory 15, and executes the loaded temperature adjusting program 12.

The I/F 17 communicates various types of information with the console 3 by wired communication or wireless communication. In addition, the I/F 17 is connected to the temperature sensor 25a, the temperature sensor 25b, the heater 26, and the cooling fan 27 in a wired manner, acquires information on temperatures detected by the temperature sensor 25a and the temperature sensor 25b, and outputs a control signal for driving the heater 26 and the cooling fan 27.

The temperature adjusting program 12 is stored in a storage device of a server computer connected to a network or in a network storage in a state of being accessible from the outside, and is downloaded and installed on a computer constituting the temperature adjusting device 10 in accordance with a request. Alternatively, the program is distributed by being recorded on a recording medium such as a digital versatile disc (DVD) or a compact disc read only memory (CD-ROM), and is installed on the computer constituting the temperature adjusting device 10 from the recording medium through, for example, the console 3.

Next, a functional configuration of the temperature adjusting device according to the present embodiment will be described. FIG. 4 is a diagram showing the functional configuration of the temperature adjusting device according to the present embodiment. As shown in FIG. 4, the temperature adjusting device 10 comprises an information acquisition unit 31, a setting unit 32, and a controller 33. Then, the CPU 11 executes the temperature adjusting program 12 to function as the information acquisition unit 31, the setting unit 32, and the controller 33.

The information acquisition unit 31 receives an instruction related to temperature control of the detector panel 9, which is performed by an operator from the console 3. For example, in the present embodiment, instruction information in which the power-saving mode is set from the console 3 during the operation mode and information on the maintenance time during which the CT apparatus 2 is maintained in the power-saving mode are acquired. Here, in a case where the operator inputs the maintenance time in the power-saving mode from the console 3, the information acquisition unit 31 acquires information on the input maintenance time as it is. In a case where the operator inputs the activation time of the CT apparatus 2 from the console 3, the information acquisition unit 31 derives a time from the current time to the activation time as the maintenance time, so that the information on the maintenance time is acquired.

The setting unit 32 determines whether or not the maintenance time is equal to or longer than a threshold value Th1. The threshold value Th1 is, for example, 1 to 2 hours. In a case where the maintenance time is equal to or longer than the threshold value Th1, the holding temperature of the detector panel 9 during the power-saving mode is set in accordance with the maintenance time. In the present embodiment, the longer the maintenance time is, the lower the holding temperature of the detector panel 9 is set. Here, during the operation mode in which the CT apparatus 2 is activated, the temperature of the detector panel 9 is set to, for example, 45° C. Therefore, in the present embodiment, the holding temperature of the detector panel 9 is set to a value smaller than 45° C. For example, in a case where the maintenance time is 4 hours, the setting unit 32 sets the holding temperature of the detector panel 9 to 10° C. In this case, the setting unit 32 sets the holding temperature to a temperature that is further lower by about 5° C. each time the maintenance time is doubled. Here, a relationship between the maintenance time and the holding temperature may be experimentally determined in accordance with a degree of deterioration of the detector panel 9 in a case where various maintenance times of the detector panel 9 are maintained by various holding temperatures.

The controller 33 controls driving of the heater 26 and the cooling fan 27 to adjust the temperature of the detector panel 9 such that the temperature of the detector panel 9 is set to the holding temperature.

On the other hand, in a case where a temperature change after the CT apparatus 2 is switched from the operation mode to the power-saving mode is rapid, deterioration of the detector due to a heat cycle is accelerated. Therefore, in the present embodiment, the controller 33 controls the driving of the heater 26 and the cooling fan 27 such that the temperature change after the CT apparatus 2 is switched from the operation mode to the power-saving mode is, for example, a decrease of 10° C. per 30 minutes. As a result, the controller 33 adjusts the temperature of the detector panel 9 such that the temperature change is constant.

That is, the controller 33 controls the driving of the heater 26 and the cooling fan 27 such that the temperature change of the detector panel 9 is constant by turning on the heater 26 and turning off the cooling fan 27, or conversely, turning off the heater 26 and turning on the cooling fan 27. In this case, in a case where the heater 26 is adjustable to a predetermined temperature, the controller 33 may perform temperature adjustment of the heater 26 such that the temperature change is constant. In addition, in a case where the rotation speed of the cooling fan 27 can be changed, the temperature change may be constant by changing the rotation speed of the cooling fan 27.

In addition, in a case where a capturing time is long or an environmental temperature is extremely high, the temperature of the detector panel 9 may be higher than that in the operation mode in a case where the CT apparatus 2 is switched from the operation mode to the power-saving mode. In this case, in a case where the cooling fan 27 is driven such that the temperature of the detector panel 9 is set to the holding temperature after the CT apparatus 2 is switched from the operation mode to the power-saving mode, the temperature change is rapid, and as a result, the deterioration of the detector due to the heat cycle is accelerated. Therefore, in a case where the temperature of the detector panel 9 is equal to or higher than a second threshold value Th2 in a case where the CT apparatus 2 is set to the power-saving mode, the controller 33 delays a start of processing of controlling the driving of the heater 26 and the cooling fan 27. Here, the temperature of the detector panel 9 during the operation mode is, for example, 45° C. The second threshold value Th2 is set to, for example, 50° C. which is 5° C. higher than 45° C.

In this case, the controller 33 delays the start of the processing of controlling the driving of the heater 26 and the cooling fan 27 by stopping the driving of the cooling fan 27 until the temperature of the detector panel 9 is cooled to the temperature during the operation mode (that is, 45° C.). As a result, during the delay, the detector panel 9 is naturally cooled by radiating heat to an environment through the polygon 20 and the detector holding plate 24. During this period, the temperature of the detector panel 9 is measured by the temperature sensor 25a. Then, after the temperature of the detector panel 9 is cooled to the temperature during the operation mode, the controller 33 starts the processing of controlling the driving of the heater 26 and the cooling fan 27 to adjust the temperature of the detector panel 9 such that the temperature change is constant.

In a case where the maintenance time is less than the threshold value Th1, the controller 33 prohibits the processing of controlling the driving of the heater 26 and the cooling fan 27. Accordingly, since the heater 26 and the cooling fan 27 are not driven, the temperature adjusting device 10 does not perform temperature adjustment processing.

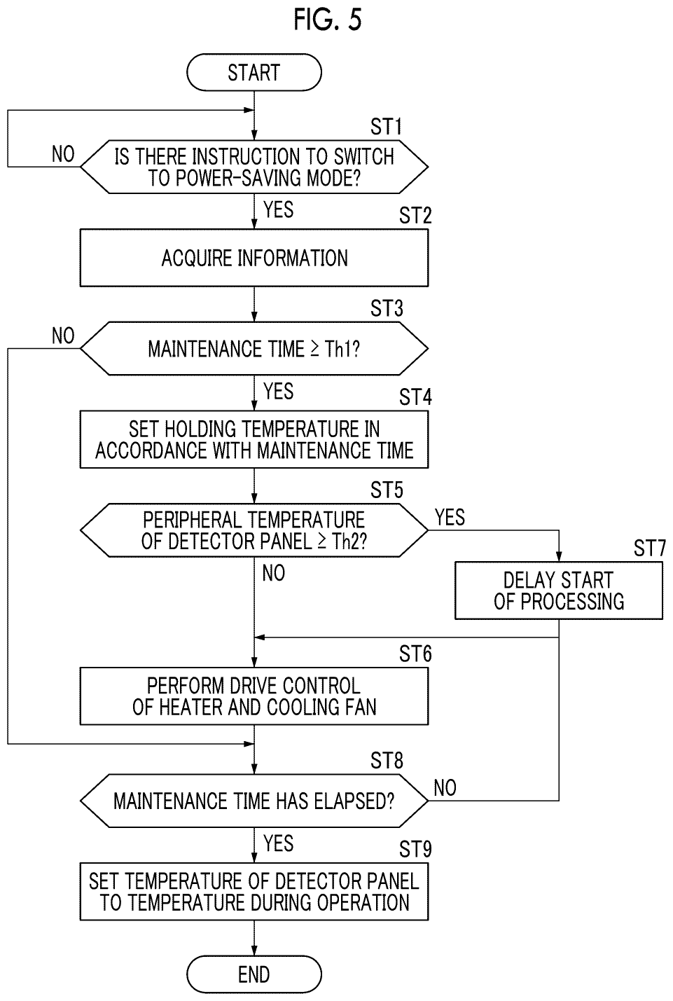

Next, processing performed in the present embodiment will be described. FIG. 5 is a flowchart showing a process performed in the present embodiment. The information acquisition unit 31 monitors whether or not an instruction to switch to the power-saving mode is issued (step ST1). In a case where a positive determination is made in step ST1, the information acquisition unit 31 acquires the instruction information in which the power-saving mode is set and the information on the maintenance time during which the CT apparatus 2 is maintained in the power-saving mode (information acquisition; step ST2).

Next, the setting unit 32 determines whether or not the maintenance time is equal to or longer than the first threshold value Th1 (step ST3). In a case where a negative determination is made in step ST3, the controller 33 proceeds to processing of step ST8 without driving the heater 26 and the cooling fan 27. In a case where a positive determination is made in step ST3, the setting unit 32 sets the holding temperature of the detector panel 9 during the power-saving mode in accordance with the maintenance time (step ST4).

Then, in a case where the power-saving mode is set, the controller 33 determines whether or not the peripheral temperature of the detector panel 9 is equal to or higher than the second threshold value Th2 (step ST5). In a case where a negative determination is made in step ST5, the controller 33 controls the driving of the heater 26 and the cooling fan 27 such that the temperature of the detector panel 9 is set to the holding temperature at a certain ratio (step ST6).

On the other hand, in a case where a positive determination is made in step ST5, the controller 33 delays the start of the processing of controlling the driving of the heater 26 and the cooling fan 27 until the temperature of the detector panel 9 is set to the temperature during the operation mode (processing start delay; step ST7), and proceeds to processing of step ST6.

Subsequently, the controller 33 determines whether or not the maintenance time has elapsed (step ST8). In a case where a negative determination is made in step ST8, the controller 33 returns to step ST6, and processing of steps ST6 and ST8 is repeated. In a case where a positive determination is made in step ST8, the controller 33 sets the heater 26 such that the temperature of the detector panel 9 is set to the temperature during the operation mode (step ST9), and ends the processing.

As described above, in the present embodiment, in a case where the maintenance time during which the power-saving mode is maintained is equal to or longer than the predetermined first threshold value Th1, the holding temperature of the detector panel 9 during the power-saving mode is set in accordance with the maintenance time, and the heater 26 and the cooling fan 27 are controlled such that the temperature of the detector panel 9 is set to the holding temperature. Therefore, it is possible to prevent the temperature of the detector panel 9 from being excessively lowered, and thus, it is possible to prevent the detector panel 9 from being deteriorated due to the heat cycle.

In addition, after the power-saving mode is set, the drive control of the heater 26 and the cooling fan 27 is performed such that the temperature of the detector panel 9 is set to the holding temperature at a certain ratio. As a result, it is possible to prevent the temperature from rapidly decreasing, and thus it is possible to more reliably prevent the deterioration of the detector panel 9 due to the heat cycle.

In addition, in a case where the peripheral temperature of the detector panel 9 is equal to or higher than the predetermined second threshold value Th2 in a case where the power-saving mode is set, the start of the processing of controlling the driving of the heater 26 and the cooling fan 27 is delayed as compared with a case where the peripheral temperature of the detector panel 9 is less than the second threshold value Th2. Therefore, it is possible to prevent the detector panel 9, in which switching to the power-saving mode is maintained, from being rapidly cooled from a high temperature state, and as a result, it is possible to more reliably prevent the detector panel 9 from being deteriorated due to the heat cycle.

In the above-described embodiment, the temperature sensor 25a is used to measure the temperature of the detector module 9A, but the present invention is not limited thereto. The configuration may be set such that the overall temperature of the entire detector panel 9 can be measured by a thermography camera or the like.

In addition, in the above-described embodiment, the heater 26 and the cooling fan 27 are provided in the polygon 20, but the present invention is not limited thereto. Only the heater 26 may be provided in the polygon 20. In this case, the detector panel 9 is cooled by radiating heat to the environment through the polygon 20 and the detector holding plate 24.

In addition, in the above-described embodiment, various processors described below can be used as a hardware structure of the temperature adjusting device 10. The various processors include, in addition to a CPU that is a general-purpose processor that executes software (program) to function as various processing units, a programmable logic device (PLD) of which a circuit configuration can be changed after manufacturing, such as a field-programmable gate array (FPGA), and a dedicated electric circuit that is a processor having a circuit configuration dedicatedly designed for executing specific processing, such as an ASIC.

The various pieces of processing may be executed by one of the various processors or a combination of two or more processors of the same type or different types (for example, a plurality of FPGAs and a combination of CPU and FPGA). Further, a plurality of processing units may be configured with one processor. As an example where a plurality of processing units are composed of one processor, there is a form in which a processor that realizes all functions of a system including a plurality of processing units into one integrated circuit (IC) chip is used, such as a system on a chip (SOC).

Hereinafter, the appendices of the present disclosure will be described.

### Appendix 1

A temperature adjusting device of a radiography apparatus including a detector that detects radiation emitted from a radiation source and transmitted through a subject and a temperature adjuster that adjusts a temperature of the detector, the temperature adjusting device comprising:
a processor,
wherein the processor is configured to
   acquire instruction information for setting the radiography apparatus to a power-saving mode in which power consumption is smaller than power consumption in a case where the radiography apparatus is operated, and information on a maintenance time during which the power-saving mode is maintained,
   set a holding temperature of the detector during the power-saving mode in accordance with the maintenance time in a case where the maintenance time is equal to or longer than a predetermined first threshold value, and
   control driving of the temperature adjuster such that the temperature of the detector is set to the holding temperature.

### Appendix 2

The temperature adjusting device according to appendix 1,
wherein the processor is configured to control the driving of the temperature adjuster such that the temperature of the detector is set to the holding temperature at a certain ratio after the power-saving mode is set.

### Appendix 3

The temperature adjusting device according to appendix 1 or 2,
wherein the processor is configured to, in a case where the power-saving mode is set, delay a start of processing of controlling the driving of the temperature adjuster in a case where a peripheral temperature of the detector is equal to or higher than a predetermined second threshold value, as compared with a case where the peripheral temperature of the detector is lower than the second threshold value.

### Appendix 4

The temperature adjusting device according to any one of appendices 1 to 3,
wherein the processor is configured to prohibit processing of controlling the driving of the temperature adjuster such that the temperature of the detector is set to the holding temperature in a case where the maintenance time is less than the first threshold value.

### Appendix 5

A radiography apparatus comprising:
a detector that detects radiation emitted from a radiation source and transmitted through a subject;
a temperature adjuster that adjusts a temperature of the detector; and
the temperature adjusting device according to any one of appendices 1 to 4.

### Appendix 6

The radiography apparatus according to appendix 5,
wherein the detector is a photon counting-type detector that outputs a detection signal corresponding to a photon energy of the radiation.

### Appendix 7

The radiography apparatus according to appendices 5 or 6,
wherein the temperature adjusting device includes a heater.

### Appendix 8

The radiography apparatus according to any one of appendices 5 to 7,
wherein the temperature adjusting device includes a cooling fan.

### Appendix 9

A temperature adjusting method of a radiography apparatus including a detector that detects radiation emitted from a radiation source and transmitted through a subject and a temperature adjuster that adjusts a temperature of the detector, the temperature adjusting method comprising:
causing a computer to execute
   acquiring instruction information for setting the radiography apparatus to a power-saving mode in which power consumption is smaller than power consumption in a case where the radiography apparatus is operated, and information on a maintenance time during which the power-saving mode is maintained,
   setting a holding temperature of the detector during the power-saving mode in accordance with the maintenance time in a case where the maintenance time is equal to or longer than a predetermined first threshold value, and
   controlling driving of the temperature adjuster such that the temperature of the detector is set to the holding temperature.

### Appendix 10

A temperature adjusting program of a radiography apparatus including a detector that detects radiation emitted from a radiation source and transmitted through a subject and a temperature adjuster that adjusts a temperature of the detector, the temperature adjusting program comprising:
causing a computer to execute
   a procedure of acquiring instruction information for setting the radiography apparatus to a power-saving mode in which power consumption is smaller than power consumption in a case where the radiography apparatus is operated, and information on a maintenance time during which the power-saving mode is maintained,
   a procedure of setting a holding temperature of the detector during the power-saving mode in accordance with the maintenance time in a case where the maintenance time is equal to or longer than a predetermined first threshold value, and
   a procedure of controlling driving of the temperature adjuster such that the temperature of the detector is set to the holding temperature.

What is claimed is:

1. A temperature adjusting device of a radiography apparatus including a detector that detects radiation emitted from a radiation source and transmitted through a subject and a temperature adjuster that adjusts a temperature of the detector, the temperature adjusting device comprising:
a processor,
wherein the processor is configured to
acquire instruction information for setting the radiography apparatus to a power-saving mode in which power consumption is smaller than power consumption in a case where the radiography apparatus is operated, and information on a maintenance time during which the power-saving mode is maintained,
set a holding temperature of the detector during the power-saving mode in accordance with the maintenance time in a case where the maintenance time is equal to or longer than a predetermined first threshold value, and
control driving of the temperature adjuster such that the temperature of the detector is set to the holding temperature.

2. The temperature adjusting device according to claim 1,
wherein the processor is configured to control the driving of the temperature adjuster such that the temperature of the detector is set to the holding temperature at a certain ratio after the power-saving mode is set.

3. The temperature adjusting device according to claim 1,
wherein the processor is configured to, in a case where the power-saving mode is set, delay a start of processing of controlling the driving of the temperature adjuster in a case where a peripheral temperature of the detector is equal to or higher than a predetermined second threshold value, as compared with a case where the peripheral temperature of the detector is lower than the second threshold value.

4. The temperature adjusting device according to claim 1,
wherein the processor is configured to prohibit processing of controlling the driving of the temperature adjuster such that the temperature of the detector is set to the holding temperature in a case where the maintenance time is less than the first threshold value.

5. A radiography apparatus comprising:
a detector that detects radiation emitted from a radiation source and transmitted through a subject;
a temperature adjuster that adjusts a temperature of the detector; and
the temperature adjusting device according to claim 1.

6. The radiography apparatus according to claim 5,
wherein the detector is a photon counting-type detector that outputs a detection signal corresponding to a photon energy of the radiation.

7. The radiography apparatus according to claim 5,
wherein the temperature adjusting device includes a heater.

8. The radiography apparatus according to claim 5,
wherein the temperature adjusting device includes a cooling fan.

9. A temperature adjusting method of a radiography apparatus including a detector that detects radiation emitted from a radiation source and transmitted through a subject and a temperature adjuster that adjusts a temperature of the detector, the temperature adjusting method comprising:
causing a computer to execute
acquiring instruction information for setting the radiography apparatus to a power-saving mode in which power consumption is smaller than power consumption in a case where the radiography apparatus is operated, and information on a maintenance time during which the power-saving mode is maintained,
setting a holding temperature of the detector during the power-saving mode in accordance with the maintenance time in a case where the maintenance time is equal to or longer than a predetermined first threshold value, and
controlling driving of the temperature adjuster such that the temperature of the detector is set to the holding temperature.

10. A non-transitory computer-readable storage medium that stores a temperature adjusting program of a radiography apparatus including a detector that detects radiation emitted from a radiation source and transmitted through a subject and a temperature adjuster that adjusts a temperature of the detector, the temperature adjusting program comprising:
causing a computer to execute
a procedure of acquiring instruction information for setting the radiography apparatus to a power-saving mode in which power consumption is smaller than power consumption in a case where the radiography apparatus is operated, and information on a maintenance time during which the power-saving mode is maintained,
a procedure of setting a holding temperature of the detector during the power-saving mode in accordance with the maintenance time in a case where the maintenance time is equal to or longer than a predetermined first threshold value, and
a procedure of controlling driving of the temperature adjuster such that the temperature of the detector is set to the holding temperature.
